(19) United States
(12) Patent Application Publication
(10) Pub. No.: US 2008/0232712 A1
(43) Pub. Date: Sep. 25, 2008

(54) Image composer for composing an image by extracting a partial region not common to plural images

(75) Inventors: Michiyo MATSUI, Saitama (JP); Yoshinori OHKUMA, Saitama (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/076,383

(22) Filed: Mar. 18, 2008

(30) Foreign Application Priority Data
Mar. 23, 2007 (JP) 2007-76035

(51) Int. Cl. G06K 9/36

(52) U.S. Cl. 382/277

(57) ABSTRACT

In an image composer includes a storage for storing a first and a second image, a region classifier compares the first image with the second image to extract as a non-common sub-region a partial region of one of the two images that does not have a similar pixel property to that of the other image. An image composing unit superimposes the extracted non-common sub-region of one of the images onto the other image to produce a resultant composite image.

### BACKGROUND OF THE INVENTION

1. Field of the Invention

The present invention relates to an image composer, and more specifically to an image composer for combining two or more images to produce a composite image.

2. Description of the Background Art

Conventionally, in order to produce a composite image, two or more photographs are taken, for example, by a camera supported on a tripod stand or the like and its self-timer or remote control function activated and then recorded in the form of original photographs to be combined together. As examples of method for producing a composite image, one method is of physically combining such two or more photographs with paste, and another method is of loading the image data of plural photographs on a personal computer to produce a single frame of composite image through manual operation on the display screen of the computer. In these methods using plural photographs obtained with a camera supported on a tripod, the background scenes such as a field view, buildings, etc., are generally not changed between the original photographs, which are therefore can be conveniently used to produce a composite image. It is, however, a burden or time-consuming to carry the tripod stand and attach the camera to the stand at a photographing site.

A recent development on digitalization of photographing makes it easier to produce composite photographs by using a personal computer. In U.S. patent application publication No. US 2002/0030634 A1 to Noda et al., for example, a method is disclosed for using on a personal computer digital images of, e.g. a background scene and a subject to selectively cut out a required part of a digital image and paste that part onto another digital image to thereby produce a resultant composite image.

However, the operation according to Noda et al., is potentially troublesome because the selection of trimming a range, i.e. cutting off a part, of the image and the determination of a position on which that part is to be pasted must be performed by manual operation. Further, when the images are different in scale or one image is rotated with respect to the other, the part needs to be enlarged or reduced, or rotated before pasted, the operation will be more troublesome.

### SUMMARY OF THE INVENTION

It is an object of the present invention to provide an image composer that is capable of readily producing a composite image.

In accordance with the present invention, a partial region of an image not common to another image is extracted therefrom for producing a composite image. More specifically, an image composer according to the invention comprises: a storage for storing data of a first and a second images; a region classifier for comparing the first and second images with each other, and extracting as a non-common sub-region a partial region of one of the images which region is not similar in its pixel property to the corresponding region of the other image; and an image composing unit for superimposing the non-common sub-region of the image on the other image to produce a composite image.

Thus, the region classifier compares the first image and second image read out from the storage, thereby extracting as a non-common sub-region a partial region of the image which region is not similar in its pixel property to the corresponding region of the other image. The image composing unit is able to produce a composite image by superimposing the extracted non-common sub-region of the image on the other image.

First and second images preferably contain a common subject in a part of the region thereof. In such a case, the image composing unit decides, based on the position of the common subject, a position in the other image where the non-common sub-region will be superimposed.

Thus, the image composing unit is able to decide, based on the position of the common subject, a position in the other image where the non-common sub-region of the one image is superimposed, and produce a composite image.

According to the present invention, it is possible to produce a composite image readily by extracting a non-common sub-region from two or more images.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing an embodiment of an image composer in accordance with the present invention;

FIG. 2 is a flow chart useful for understanding the process carried out in the image composer shown in FIG. 1;

FIG. 3 shows a base image;

FIG. 4 shows a superimposition image;

FIG. 5 includes two parts, one part (A) showing the base image shown in FIG. 3 with its extracted feature points represented with crosses, and the other part (B) showing the superimposition image shown in FIG. 4 with its extracted feature points represented with crosses;

FIG. 6A shows the base image shown in FIG. 3;

FIG. 6B shows the superimposition image shown in FIG. 4 with its extracted feature points represented with crosses, its non-common sub-region against the base image shown in FIG. 6A represented with a shaded rectangle, and the diagonal corners of the rectangle represented with square dots;

FIG. 6C shows a composite image produced from the images shown in FIGS. 6A and 6B, representing the superimposed non-common sub-region with a dotted rectangle and the diagonal corners of the rectangle with square dots;

FIG. 7 is a schematic block diagram showing an alternative embodiment of the image composer in accordance with the present invention;

FIG. 8 is a flow chart useful for understanding the process executed in the image composer shown in FIG. 7;

FIG. 9 includes two parts, one part (A) shows a base image with its extracted feature points represented with crosses, and the other part (B) shows a superimposition image with its extracted feature points represented with crosses, its non-common sub-region against the base image shown in FIG. 9, part (A), represented with a shaded rectangle, and the diagonal corners of the rectangle represented with square dots;

FIG. 10 shows a composite image produced from the images shown in FIG. 9, parts (A) and (B), representing the superimposed non-common sub-region with a dotted rectangle and the diagonal corners of the rectangle with square dots;

FIG. 11 includes two parts, one part (A) showing a base image representing its extracted feature points with crosses, and the other part (B) showing a superimposition image with its extracted feature points represented with crosses, its non-common sub-region against the base image shown in FIG. 11, part (A), represented with a shaded rectangle and the corners of the rectangle represented with square dots;

FIG. 12A shows the base image shown in FIG. 11, part (A);

FIG. 12B shows the superimposition image which is transformed with its coordinate system matched with that of the base image shown in FIG. 12A, where a solid rectangle shows the corresponding region of the base image shown in FIG. 12A, a dotted rectangle shows the whole region of the transformed superimposition image, a shaded rectangle shows the transformed non-common sub-region and the square dots show the corners of the rectangle;

FIG. 13 shows a composite image produced from the images shown in FIGS. 12A and 12B, where a dotted rectangle shows the superimposed non-common sub-region shown in FIG. 12B and the square dots show the corners of the rectangle;

FIG. 14 includes two parts, one part (A) showing a base image with its extracted feature points represented with crosses, and the other part (B) showing a superimposition image with its extracted feature points represented with crosses and its non-common sub-region against the base image shown in FIG. 14, part (A), represented with a shaded rectangle;

FIG. 15 shows a composite image produced from the images shown in FIG. 14, parts (A) and (B), representing the superimposed non-common sub-region with a dotted rectangle;

FIG. 16 includes two parts, one part (A) showing a base image with its extracted feature points represented with crosses, and the other part (B) showing a superimposition image with its extracted feature points represented with crosses and its non-common sub-regions against the base image shown in FIG. 16, part (A), represented with shaded rectangles; and

FIG. 17 shows a composite image produced from the images shown in FIG. 16, parts (A) and (B), where dotted rectangles show the regions of the superimposed non-common sub-regions.

### DESCRIPTION OF THE PREFERRED EMBODIMENTS

Now, preferred embodiments of an image composer according to the present invention will be described in detail with reference to the accompanying drawings. For the purpose of making the present invention understood easier, the description will specifically be made on the case where two original images are combined with each other to form a resultant single image. In that case, one of the two original images which is used as a base for such a resultant single image will hereinafter be referred to as a base image, while the other image part of which not common to at least part of the base image is extracted to be superimposed or pasted onto the base image will hereinafter be referred to as a superimposition image. Further, the single image produced from the two original images will hereinafter be referred to as a composite image.

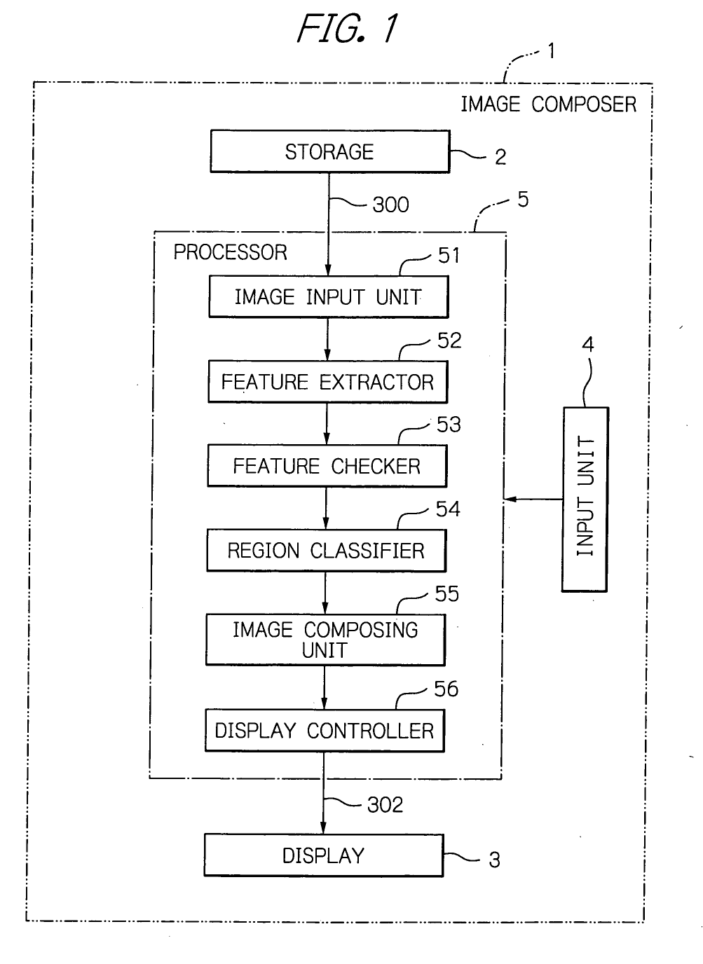

Referring initially to FIG. 1, there is shown an embodiment of an image composer in accordance with the present invention. The present embodiment is based on the assumption that a base image and a superimposition image have been photographed at approximately the same angle and scale value. In this respect, this embodiment may differ from an alternative embodiment described later. FIG. 1 schematically shows in a block diagram the structure of an image composer 1 according to the embodiment, which may be implemented by a computer such as a personal computer and includes a storage 2, a display 3, an input unit 4, and a processor 5, which are interconnected as illustrated.

The storage 2 is adapted for storing various information in the form of digital data, and may be implemented by, e.g. a read-only memory (ROM) and a hard-disk drive (HDD). Information to be stored in the storage 2 may be operational program sequences runnable on the processor 5 and various kinds of image data including base image data and superimposition image data, and so forth.

The display 3 is adapted for visualizing and displaying information, and may be implemented by a liquid crystal display or an electro-luminescence display, for example. A variety of image data and other pertinent data are displayed on the display 3 under the control of the processor 5.

The input unit 4 is adapted for entering information to the image composer 1, and may include a keyboard and a pointing device such as a mouse. The input unit 4 is used to feed information that was input by the user to the processor 5.

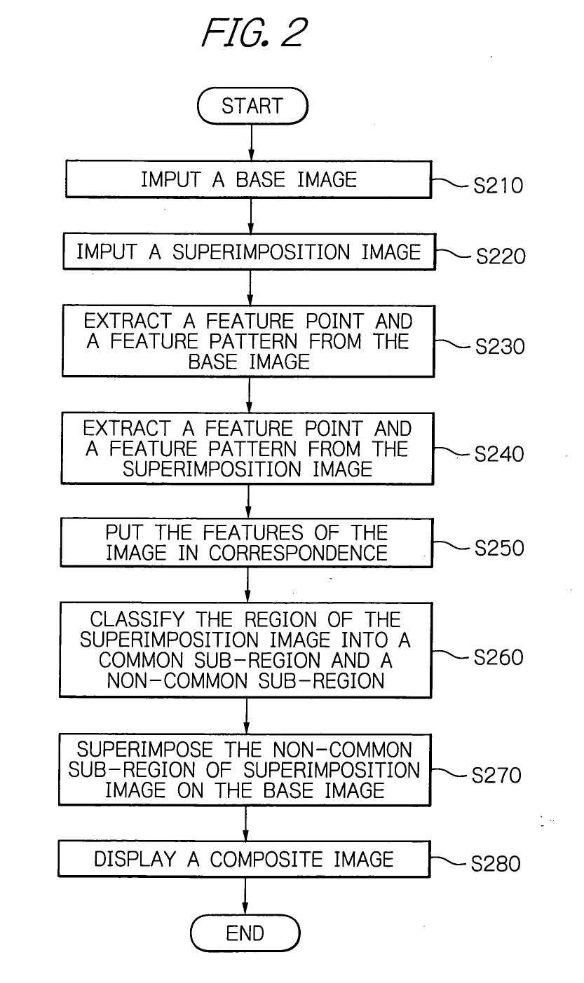

The processor 5 is adapted for controlling the entire operations that are to be performed in the image composer 1, and may include a central processing unit (CPU), a random access memory (RAM), for example. The processor 5 includes operational functions represented by several functional blocks such as an image input unit 51, a feature extractor 52, a feature checker 53, a region classifier 54, an image composing unit 55, and a display controller 56. Those units 51 to 56 will be described briefly here, and a detailed description of them will be given later with reference to FIG. 2.

The image input unit 51 is adapted to be responsive to, for example, an image compositing instruction that was input through the input unit 4 by the user to read out data representative of a base image and a superimposition image 300 from the storage 2. Signals are designated with reference numerals designating connections on which they are conveyed.

The feature extractor 52 is adapted to receive the data of base and superimposition images from the image input unit 51, and then extract their feature points and feature patterns, i.e. pixel properties. In this embodiment, the term “feature point” is used to represent a specific part of an image such as edges and corners of subjects in the image, while the term “feature pattern” is used to represent properties of the feature points. A detailed description of them is to be described later.

The feature checker 53 is adapted to compare each of the feature points of a base image with the feature points of a superimposition image based on the feature pattern of that feature point. When similarity in feature pattern substantially equal to or over a predetermined threshold is found between a feature point of the base image and that of the superimposition image, both of the points thus found are determined as a pair of points corresponding with each other. The value of the threshold may be determined depending upon purposes or accuracy.

The region classifier 54 is adapted to sort or sub-divide the region of a superimposition image into a non-common sub-region and a common sub-region. The non-common sub-region, in the superimposition image, refers to a sub-region that is occupied by an object not present in the base image, i.e. a partial region having feature patterns whose similarity to those in the corresponding sub-region of the base image is lower than the predetermined threshold. The common sub-region, in the superimposition image, means a sub-region other than the non-common sub-region. The region classifier 54 may be adapted to decide the non-common sub-region, for instance, by a rectangle circumscribing a partial set of feature points not adopted as a pair of corresponding points such as to contain the set therein. A partial set of feature points denotes a set of plural feature points of one object, such as a person or an automobile, contained in an image. One superimposition image may contain one or more partial sets of features.

The image composing unit 55 is adapted to overlay or superimpose, i.e. paste, a non-common sub-region of the superimposition image onto the base image to produce a composite image in the form of digital data.

The display controller 56 is adapted to provide the display 3 with an instruction to display a composite image 302 produced by the composing unit 55. The display 3 may be of the type provided outside the composer 1, and in that case the display controller 56 may be adapted to control such an external display so as to cause the composite image 302 to be displayed on the external display.

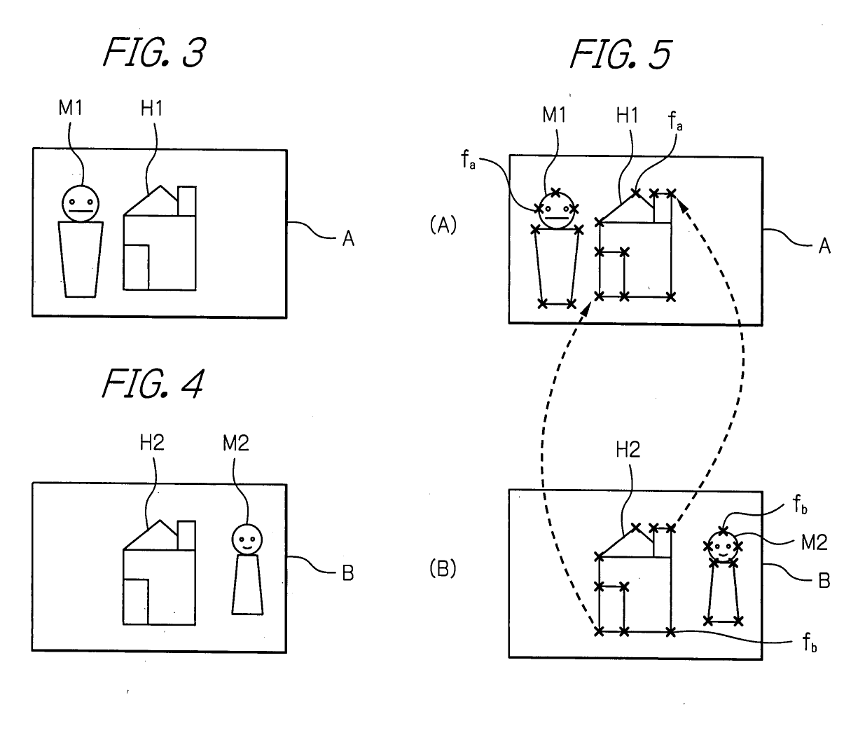

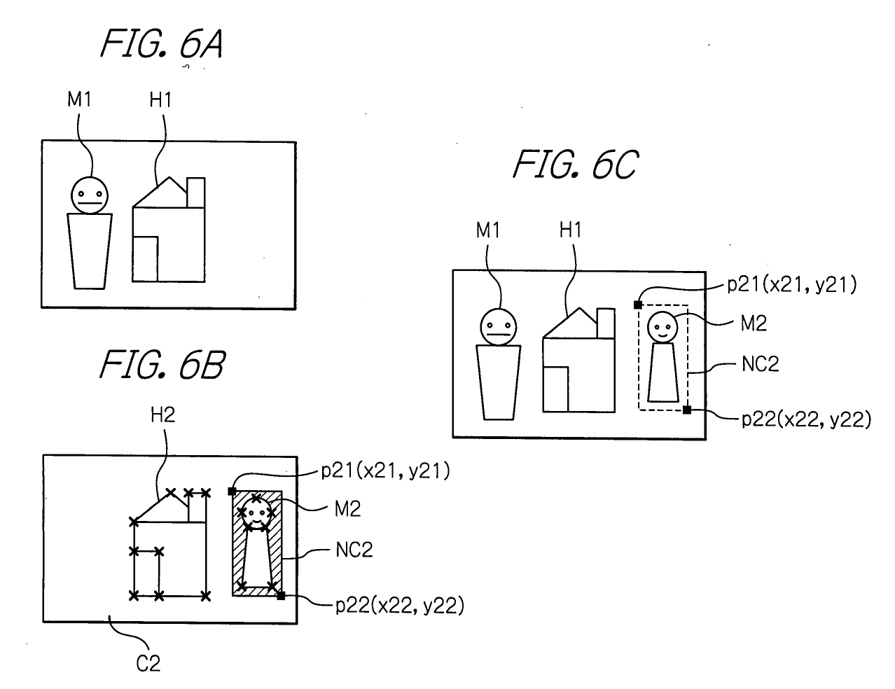

Now, processing steps in the instant embodiment will be described by referring to FIGS. 2, 3 and 4. FIG. 2 shows the processing steps to be carried out in the image composer 1 of the embodiment. FIG. 3 shows a base image and FIG. 5, part (A), also shows the same base image with its extracted feature points fa represented with crosses. FIG. 4 shows a superimposition image and FIG. 5, part (B), also shows the same superimposition image with its extracted feature points fb represented with crosses. Further, FIG. 6A shows the same base image as FIG. 3. FIG. 6B shows the same superimposition image as FIG. 4 with its extracted feature points represented with crosses, its non-common sub-region against the base image shown in FIG. 6A with a shaded rectangle and the diagonal corners of the rectangle with square dots. FIG. 6C shows a composite image in which the base and superimposition images have been combined together, where the dotted rectangle shows the superimposed non-common sub-region shown in FIG. 6B and the diagonal corners of the rectangle with square dots.

The present embodiment is specifically adapted to define the feature point of an image as, for example, the point detected as the position of the maxima of a Harris operation element of the image and defining the edge or boundary of an object in the image. For a more detailed discussion on the Harris operation element, see, for example, C. Harris et al., “A combined Corner and Edge Detector,” Proc., 4^{th} Alvey Vision Conf., pp. 147-151, 1988, cited as merely teaching the general background art.

The instant embodiment is adapted to define a feature pattern as a differential luminance value, in the form of differential luminance vector, of the portion surrounding a feature point, the differential luminance value not being affected in its nature by the scale value and orientation of the image. For a more detailed discussion on the differential luminance value of the portion surrounding a feature point, see, for example, C. Schumid et al., “Local Greyvalue Invariants for Image Retriever,” IEEE Trans., PAMI, Vol. 19, No. 5, pp. 530-535, 1997, also cited here as merely teaching the general background art.

Besides, the feature pattern may be of scalar values, such as pixel values or the average value thereof, calculated from one or more pixels, other kinds of vector, e.g. luminance vectors, and so on.

Below, a description will be given of the processing steps in the image composer 1 that are executed when the user manipulates the input unit 4 to instruct the composer 1 to produce a composite image. In operation, the digital data representative of a base image and a superimposition image have been stored in the storage 2 in advance.

Initially, the image input unit 51 of the processor feeds the base image, i.e. the image A shown in FIG. 3, from the storage 2 into the processor 5 (step S210). This base image contains a sub-region common to the superimposition image, such as background scene, buildings, etc., and a partial region to which a part of the superimposition image will be pasted, i.e. the non-common sub-region. In the case of FIG. 3, the base image contains a person M1 and a house H1.

The image input unit 51 then feeds the processor 5 with the superimposition image, i.e. the image B shown in FIG. 4, which contains a subject to be added or pasted to the base image (step S220). In the present embodiment, the superimposition image contains a different person M2 and a house H2 which is the same as the house H1 of the base image.

Subsequently, the feature extractor 52 extracts feature points fa, which are represented by the crosses in FIG. 5, and a feature pattern vₐ from the base image A (step S230).

More specifically, the group Fa of the feature points fa can be represented as a set of plurality (m) of feature points fa₁ to faₘ, where m is a natural number, by the following Expression (1):

Fa={fa₁,fa₂, . . . , faₘ} (1)

The k^{th} feature faₖ can be represented by the following Expression (2), where k is a natural number not more than m:

faₖ={xₐₖ,yₐₖ,sₐₖ,θₐₖ,vₐₖ} (2)

in which x is an x-coordinate value; y is a y-coordinate value; s is a scale value, which represents the scale or reduction ratio of an image, a relative value to a predetermined reference value, for example; and θ is an angle of rotation with respect to a reference direction extending from a predetermined reference point. Note that a subscript, such as “ak”, etc., of a parameter indicates the correspondence with a feature point, such as “Faₖ”, etc.

The feature pattern vₐ can be expressed as a p-dimensional vector, as follows:

vₐₖ={vₐₖ⁽¹⁾,vₐₖ⁽²⁾, . . . , vₐₖ^{(p)}} (3)

where p is also a natural number representing the dimension.

The feature extractor 52 also extracts feature points fb represented by the crosses in FIG. 5, part (B), and a feature pattern v_{b} from the superimposition image B (step S240). In a similar way, the group Fb of the feature points fb, the k^{th} feature point fbₖ, and the feature pattern v_{bk} of the image B can respectively be represented as follows:

Fb={fb₁,fb₂, . . . , fbₙ} (4)

fbₖ={x_{bk},y_{bk},s_{bk},θ_{bk},v_{bk}} (5)

v_{bk}{v_{bk}⁽¹⁾,v_{bk}⁽²⁾, . . . , v_{bk}^{(p)}} (6)

in which the number of the feature points fb is n.

Next, the feature checker 53 puts the individual feature points of the image A and those of the image B in correspondence (step S250). More specifically, the feature checker 53 determines whether or not there is a feature point {faᵢ} of the base image A corresponding to a feature point {fbⱼ} of the superimposition image B. An example of the method of determination is of calculating the square of the Euclidean distance between features by the following Expression (7).

$$\begin{matrix}D ( i , j ) = {\sum }_{r = 1}^{P} {\{ {v}_{ai}^{( r )} - {v}_{bj}^{( r )} \}}^{2} \\ = {\{ {v}_{ai}^{( 1 )} - {v}_{bj}^{( 1 )} \}}^{2} + {\{ {v}_{ai}^{( 2 )} - {v}_{bj}^{( 2 )} \}}^{2} + … + \\ {\{ {v}_{ai}^{( p )} - {v}_{bj}^{( p )} \}}^{2}\end{matrix} \qquad ( 7 )$$

With respect to a certain value j, if i is such a value that D(i, j) is within a predetermined threshold value and is the minimum value of D(i, j), it can be determined that the feature point {faᵢ} corresponds to the feature point {fbⱼ}. Also, with respect to a certain value j, when there is no value i satisfying the condition that D(i, j) exceeds the predetermined threshold value, the feature point {fbⱼ} is determined as a point having no corresponding feature point on the base image. When there is no corresponding point pair, an object that is not present in a base image is included in a superimposition image. In both the case where there is a corresponding point pair and the case where there is no corresponding point pair, the feature checker 53 stores the result of determination in the storage 2.

Using the result obtained in step S250, the region classifier 54 sorts the region of the superimposition image B into a non-common sub-region and a common sub-region, which are referred to as NC2 and C2 in FIG. 6B, respectively (step S260). The non-common sub-region NC2 in FIG. 6B refers to an image region that contains an object not existing in the base image. More specifically, it is a region which contains feature points considered to have no corresponding point in step S250. This region, for instance, may be decided as a rectangle which entirely contains a partial set of these feature points. In this case, such a rectangle can be defined by the coordinates of its upper left end and lower right end, i.e. p21 (x21, y21) and p22 (x22, y22) in FIG. 6B, respectively.

On the other hand, the common sub-region is a sub-region considered to be the background for a composite image and can be decided, for example, as a sub-region other than the non-common sub-region.

Subsequently, the image composing unit 55 overlays or superimposes the non-common sub-region obtained in step S260 at its corresponding position in the base image to produce a composite image (step S270). Examples of image overlaying methods include a method of replacing a luminance value, a method of using the average luminance value between a superimposition image and a base image, and so forth.

The display controller 56 instructs the display 3 to display the composite image produced in step S270 (step S280). In response to the instruction, the display 3 displays the composite image on its display screen.

Thus, the image composer 1 of the present embodiment automatically decides a part of a superimposition image that will be overlaid or superimposed on a base image. Therefore the user is able to create a composite image readily by simply inputting base and superimposition images photographed at the same location and containing a subject common to both of them.

Now, an alternative embodiment of the present invention will be described in detail. This alternative embodiment does not need to use a base image and a superimposition image photographed at nearly the same orientation and scale value. More specifically, in the alternative embodiment, a common subject in a superimposition image may be different, i.e. shifted, in position, or in orientation, or in scale with respect to corresponding one in a base image. In addition, the alternative embodiment is adapted to transform, such as move, rotate, zoom or combine, a superimposition image rather than a base image. However, the system may be adapted to transform a base image without transforming a superimposition image fixed.

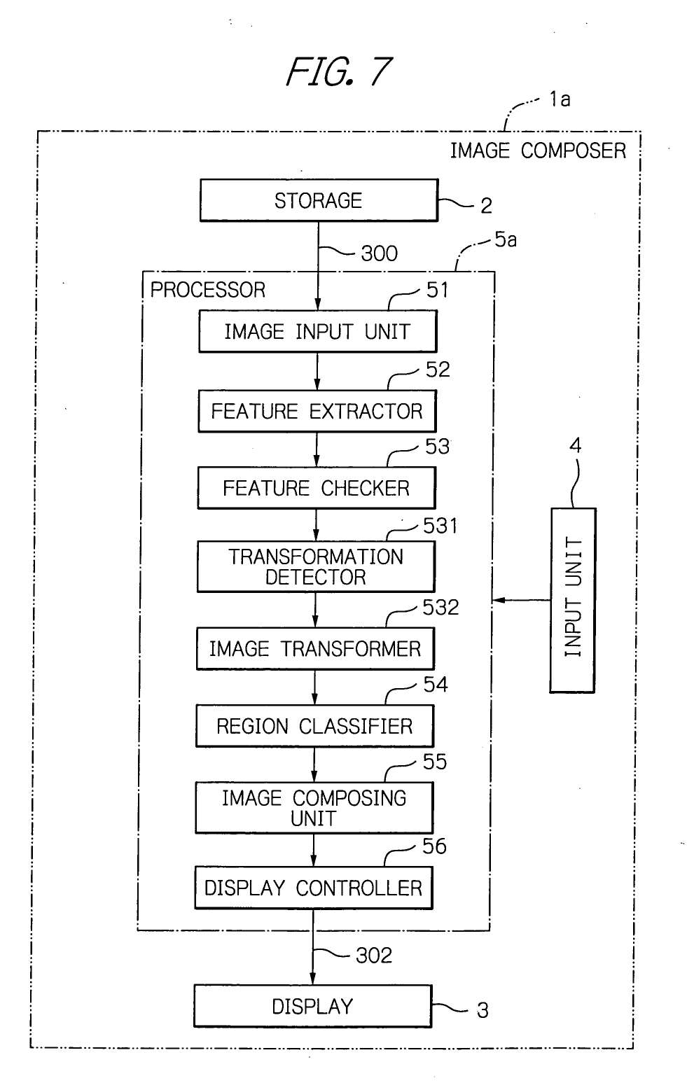

FIG. 7 shows a simplified configuration of an image composer 1a in accordance with the alternative embodiment. The image composer 1a may be the same as the image composer 1 shown in and described with reference to FIG. 1 except that a processor 5a is provided to include a transformation detector 531 and an image transformer 532 arranged between the feature checker 53 and the region classifier 54. Therefore, a description of these different parts will hereinafter be given and a repetitive description of the remaining elements will not be given for avoiding redundancy. Like components are designated with the same reference numerals.

The transformation detector 531, based on the result of checking in the feature checker 53, is adapted to calculate image transformation parameters for transforming the superimposition image as required in such a way that corresponding feature points, in pair, of the base and superimposition images are overlaid with each other.

The image transformer 532 is adapted to use the image transformation parameters calculated by the transformation detector 531 to transform the superimposition image accordingly.

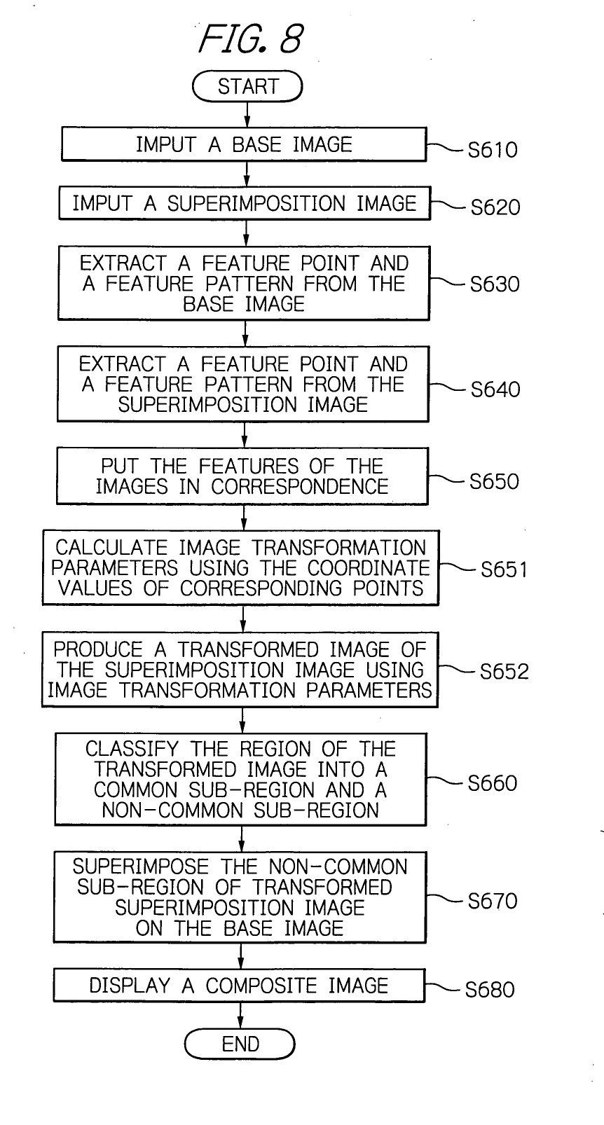

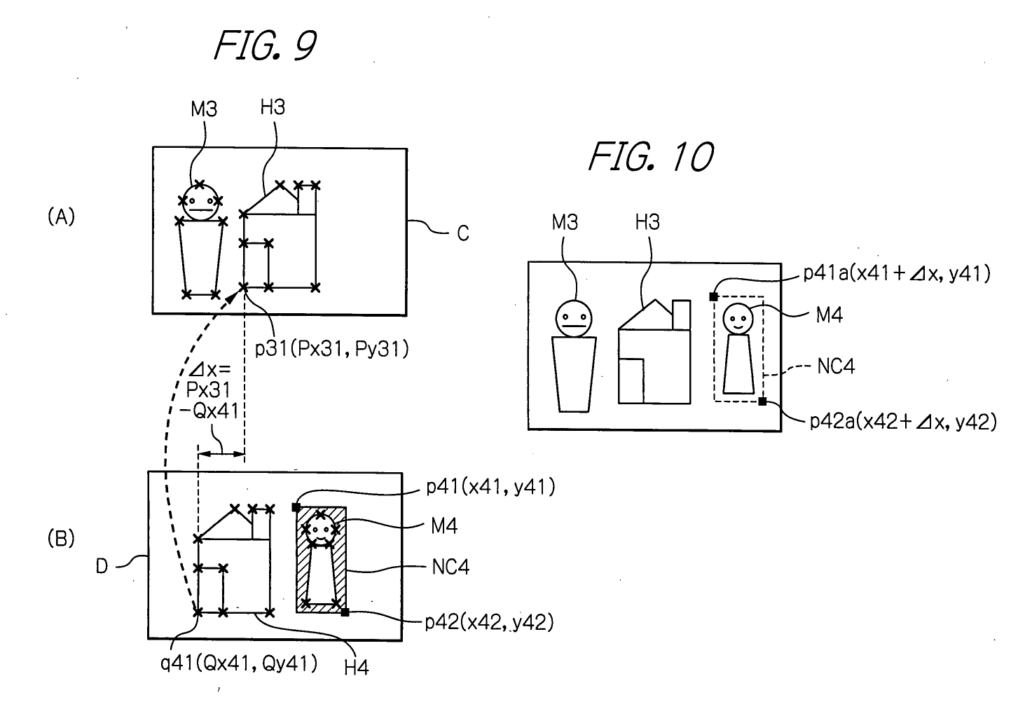

Now, processing steps in the alternative embodiment will be described with reference to FIGS. 8 to 13. FIG. 8 shows the processing steps to be carried out in the image composer 1a. FIG. 9, part (A), shows a base image C which contains a person M3 and a house H3 existing and represents their feature points with crosses. FIG. 9, part (B), shows a superimposition image D which contains another person M4 and a house H4 representing their feature points with crosses, and its non-common sub-region NC4 against the base image shown in FIG. 9, part (A), with a shaded rectangle and the diagonal points of the rectangle with square dots. The house H4 is the same as the house H3 with the common subject in the superimposition image shifted laterally in position, i.e. different from its corresponding position in the base image. FIG. 10 shows a composite image resultant from the base and superimposition images, and depicts the superimposed non-common sub-region with a dotted rectangle and the diagonal points of the rectangle with square dots.

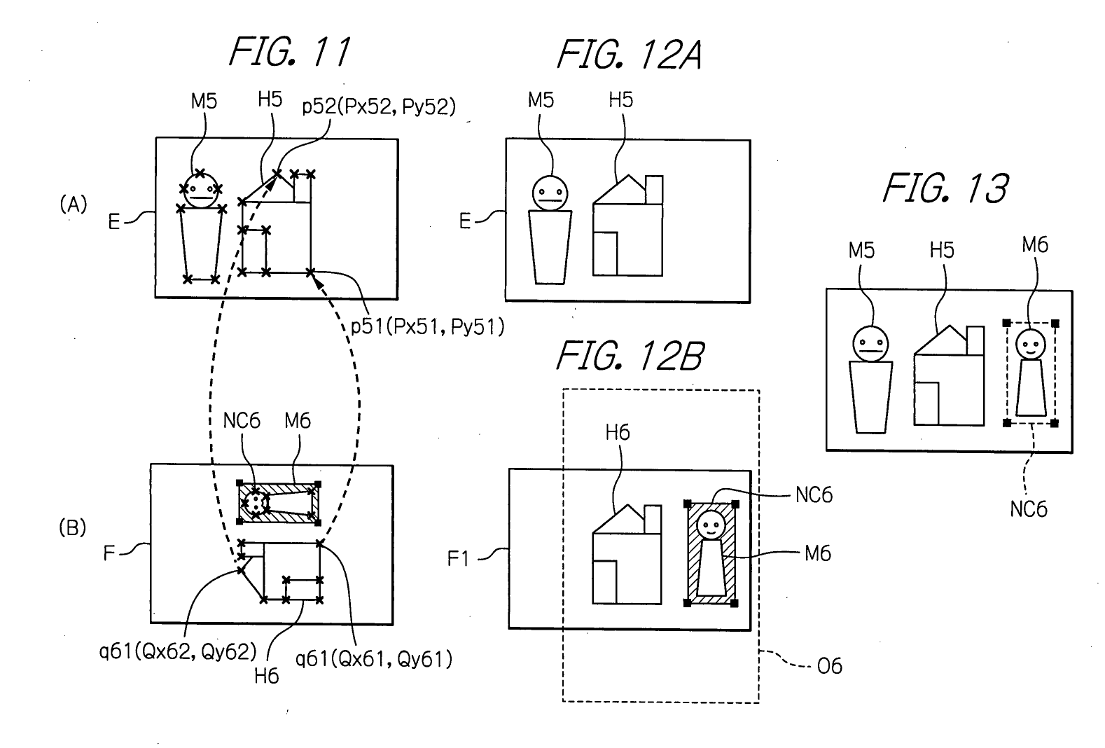

FIG. 11, part (A), shows a base image E which contains a person M5 and a house H5 with their feature points represented by crosses. Part (B), shows a superimposition image F which contains another person M6 and a house H6 with their feature points represented with crosses, its non-common sub-region NC6 against the base image shown in part (A) represented with a shaded rectangle and the corners of the rectangle represented with square dots. The house H6 is the same as the house H5. The position, orientation and scale of the common sub-region of the superimposition image are different from its corresponding position, orientation and scale in the base image, respectively. FIG. 12A shows the same base image as FIG. 11, part (A). FIG. 12B shows the superimposition image F1 which is the image F transformed so that its coordinate system coincides with the corresponding coordinate system of the base image. FIG. 13 shows the composite image of the base and superimposition images with the superimposed non-common sub-region represented with a dotted rectangle and the corners of the rectangle represented with square dots.

Well, a description will be given of the processing steps in the image composer 1a which are carried out when the user manipulates the input unit 4 to produce a composite image. In operation, the digital data of a base image and a superimposition image have already been stored in the storage 2.

As previously stated, unlike the case of the embodiment according to the image composer 1, the superimposition image may be shifted from the base image in its corresponding position, orientation and scale.

Initially, the image input unit 51 feeds the processor 5 with the digital data of the base image C or E shown in FIG. 9, part (A), or FIG. 11, part (A), from the storage 2 (step S610). The image input unit 51 then feeds the processor 5 with the superimposition image D or F shown in FIG. 9, part (B), or FIG. 11, part (B) (step S620). In this embodiment, the superimposition image, with respect to the base image, may be shifted in position as shown in FIG. 9, parts (A) and (B), or shifted in orientation as shown in FIG. 11, parts (A) and (B).

Subsequent steps S630 to S650 are the same as the aforementioned steps S230 to S250, FIG. 2, respectively. A repetitive description of the corresponding steps will not be given for avoiding redundancy.

After step S650, the transformation detector 531 calculates image transformation parameters employing the coordinate values of a corresponding point pair (step S651). More specifically, the transformation detector 531, based on the result of checking in step S650, calculates image transformation parameters for transforming the superimposition image in such a manner that corresponding points of the base and superimposition images are overlaid with each other.

For example, as shown in FIG. 9, parts (A) and (B), when the position of the superimposition image is shifted laterally from the corresponding position in the base image, the transformation detector 531 substitutes into the following Expression (8) the information about the x coordinate points (xₐᵢ and x_{bi}) of the corresponding point pair, i.e. pair of feature points of the base and superimposition images, found in step S650 to calculate an image transformation parameter, for example, Δx in this case.

Δx{Σᵣ₌₁^{t}(x_{br}−xₐᵣ)}/t={Σᵣ₌₁^{t}Δxᵣ}/t (8)

in which t represents the number of corresponding point pairs.

In FIG. 9, parts (A) and (B), the coordinate point p31 (Px31, Py31) of the base image corresponds to the coordinate point q41 (Qx41, Qy41) of the superimposition image, and the difference Δx between the x coordinate points is Px31−Qx41. Therefore, when the non-common sub-region of the superimposition image is superimposed or pasted on the base image, its upper left point p41 (x41, y41) and lower right point p42 (x42, y42) have to be shifted in a direction of x-axis by the amount of Δx. That is, they are shifted to p41a(x41+Δx, y41) and p42a(x42+Δx, y42) in the base image, respectively.

Likewise, when the superimposition image are shifted only in a direction of y-axis from its corresponding position in the base image, the transformation detector 531 substitutes into the following Expression (9) the information about the y coordinate points (yₐᵢ and y_{bi}) of the corresponding point pair to calculate an image transformation parameter, i.e. Δy in this case.

Δy={Σᵣ₌₁^{t}(y_{br}−yₐᵣ)}/t={Σᵣ₌₁^{t}Δyᵣ}/t (9)

When the base and superimposition images are different only in scale, the transformation detector 531 substitutes into the following Expression (10) the information about the scale values (sₐᵢ and s_{bi}) of the corresponding point pair to calculate an image transformation parameter, i.e. Δs in this case.

Δs={Σᵣ₌₁^{t}(s_{br}/sₐᵣ)}/t={Σᵣ₌₁^{t}Δsᵣ}/t (10)

When the base and superimposition images are different only in orientation, the transformation detector 531 substitutes into the following Expression (11) the information about the amount of orientation (θₐᵢ and θ_{bi}) of the corresponding point pair to calculate an image transformation parameter, i.e. Δθ in this case.

Δθ={Σᵣ₌₁^{t}θ_{br}−θₐᵣ)}/t={Σᵣ₌₁^{t}Δθᵣ}/t (11)

As with the example shown in FIG. 11, parts (A) and (B), when all of the position, orientation and scale are shifted between the couple of images, for example, the Hough transformation disclosed in the aforementioned C. Schumid et al., can be applied to calculating a positional difference (Δx, Δy), an orientation difference (Δθ), and a scale difference (Δs) by means of a voting process. More specifically, the voting process is implemented by:

(i) creating disjoint categories of candidates of a target value in ΔX-ΔY-ΔΘ space, i.e. a value to be specified, which categories are known as bins,
(ii) calculating values (ΔXᵣ, Δyᵣ, Δsᵣ, Δθᵣ; r=1 . . . t) of pairs by the expressions such as Expressions (8) to (11),
(iii) classifying the values into bins which the values belong to, i.e. voting for the bins, and
(iv) specifying a bin to which the most values belong and adopt an appropriate value in this bin, e.g. median of the bin, as the target value. In a case where the voting process is applied to plural image transformation parameters, the values of the parameters may be calculated, for example, in such an order of scale difference (Δs), orientation difference (Δθ) and positional difference (Δx, Δy) as the accuracy becomes higher.

In FIG. 8, after step S651, the image transformer 532 uses the image transformation parameters calculated in step S651 to transform the superimposition image F into a image F1. More specifically, the image transformer 532 substitutes the image transformation parameters (Δx, Δy, Δs, Δθ) calculated in step S651 into an affine transform equation defined by the following Expression (12), thereby transforming the coordinate system of the superimposition image into that of the base image. As to the superimposition image, the notation (x_{bj}, y_{bj}) represents the position of a point of the untransformed superimposition image F and the notation (X_{bj}, Y_{bj}) represents the corresponding position of the point (x_{bj}, y_{bj}) in the transformed superimposition image F1.

$$( \begin{matrix}{X}_{bj} \\ {Y}_{bj}\end{matrix} ) = ( \begin{matrix}Δ s \cdot cos Δ θ & - Δ s \cdot sin Δ θ \\ Δ s \cdot sin Δ θ & Δ s \cdot cos Δ θ\end{matrix} ) ( \begin{matrix}{x}_{bj} \\ {y}_{bj}\end{matrix} ) + ( \begin{matrix}Δ x \\ Δ y\end{matrix} ) \qquad ( 12 )$$

Referring to FIG. 11, parts (A) and (B), the coordinate points p51 (Px51, Py51) and p52 (Px52, Py52) of the base image shown in FIG. 11, part (A), correspond to the points q61 (Qx61, Qy61) and q62 (Qx62, Qy62) of the superimposition image shown in FIG. 11, part (B), respectively. In this state, if the affine transform expression, Expression (12), is applied to the superimposition image shown in FIG. 11, part (B), it is transformed to an superimposition image having region O6 as shown in FIG. 12B. Note that when there is only a positional difference along x-axis, in the aforementioned Expression (12), Δ=0, Δs=0, and Δθ=0.

The region classifier 54, as with step S260, classifies the region of the superimposition image into a non-common sub-region NC6 and a common sub-region, employing the result of determination obtained in step S650 (step S660), see FIG. 12B. Since this classification may be performed prior to the transformation of the superimposition image (step S652), the non-common sub-region NC6 is also shown in FIG. 11, part (B).

Subsequently, the image composing unit 55, as in step S270, overlays or pastes the non-common sub-region obtained in step S660 at the corresponding position in the base image to produce a composite image (step S670). By transforming the superimposition image, its non-common sub-region is shifted outside the corresponding region of the base image, and the non-common sub-region may be forced to be moved, or reduced, so that it is included in the corresponding region of the base image, or that effect may be given to the user by being displayed on the display 3.

The display controller 56 instructs the display 3 to display the composite image produced in step S670, corresponding to step S280. After receiving the instruction, the display 3 displays the composite image on its screen. For instance, as shown in FIG. 10, the person M3 and house H3, and person M4 are contained in a single composite image. Similarly, as shown in FIG. 13, the person M5, house H5, and person M6 are contained in a single composite image.

Thus, the image composer 1a in FIG. 7 automatically match the coordinate systems of the base and superimposition images, for example, even when the position of a background is shifted because of photography by different persons, or photographs are taken at different orientation, for example, by rotating the camera 90 degrees, according to photographer's preference. Consequently, the user is able to produce a composite image readily by simply inputting a base image and a superimposition image remaining their difference in their position or the like. Besides, a partial region of a superimposition image is superimposed on a base image so that its relative position and size do not change with respect to a common subject, whereby the user is able to produce a naturally felt composite image that looks more attractive.

While the image transformer 532 is arranged between the transformation detector 531 and the region classifier 54 with the instant alternative embodiment, it may alternatively be arranged between the region classifier 54 and the image composing unit 55, and even in this case, the same advantages are obtainable. In addition, although the entire superimposition image is transformed in this embodiment, the system may be adapted so that only its non-common sub-region may be transformed, and even that case is able to obtain the same composite image.

In the two illustrative embodiments described above, while the common subject is a house, or more broadly a building, to the base and superimposition images, the present invention is applicable to many types of common subjects so long as the image composer 1 or 1a is adapted to extract its feature points and its feature patterns. Examples are persons (or persons wearing the same clothe), vehicles such as automobiles and trains, or more broadly moving bodies, plants such as flowers and trees, animals, articles such as books and desks, and so on. Hereinafter, a description will be given of examples of common subjects other than buildings. The processing steps in the image composer 1 or 1a are practically the same as the two embodiments described above, and therefore a detailed description of the corresponding processing steps will not be given.

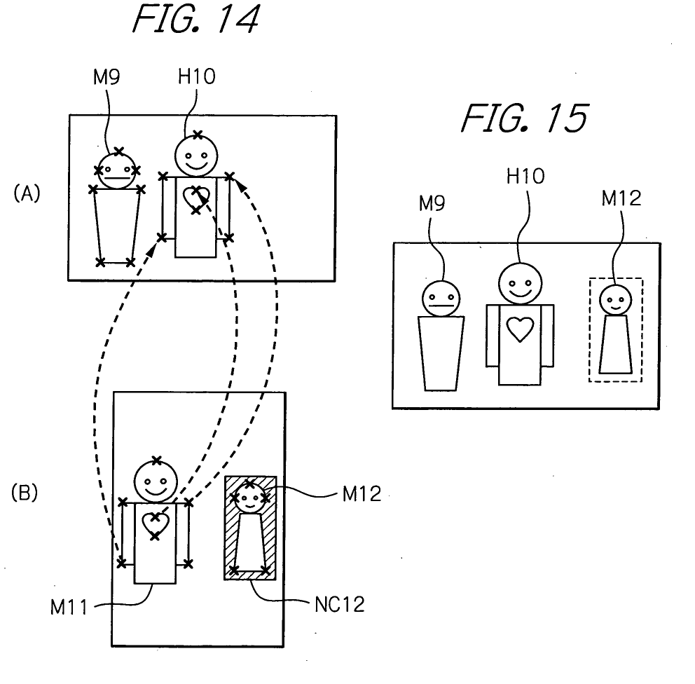

Referring to FIG. 14, parts (A) and (B), and FIG. 15, another alternative embodiment will be described, where a common subject of two images is a person wearing the same clothes and the images are combined together with respect to the person. FIG. 14, parts (A) and (B), and FIG. 15 show a base image, a superimposition image and their composition image, respectively. In FIG. 14, part (B), its non-common sub-region against the base image shown in FIG. 14, part (A), is referred to as NC12.

The base image shown in FIG. 14, part (A), contains persons M9 and M10, while the superimposition image shown in part (B) contains persons M11 and M12. The persons M10 and M11 are the same. The image composer 1 or 1a can produce their composite image with respect to the same person M10 as shown in FIG. 15.

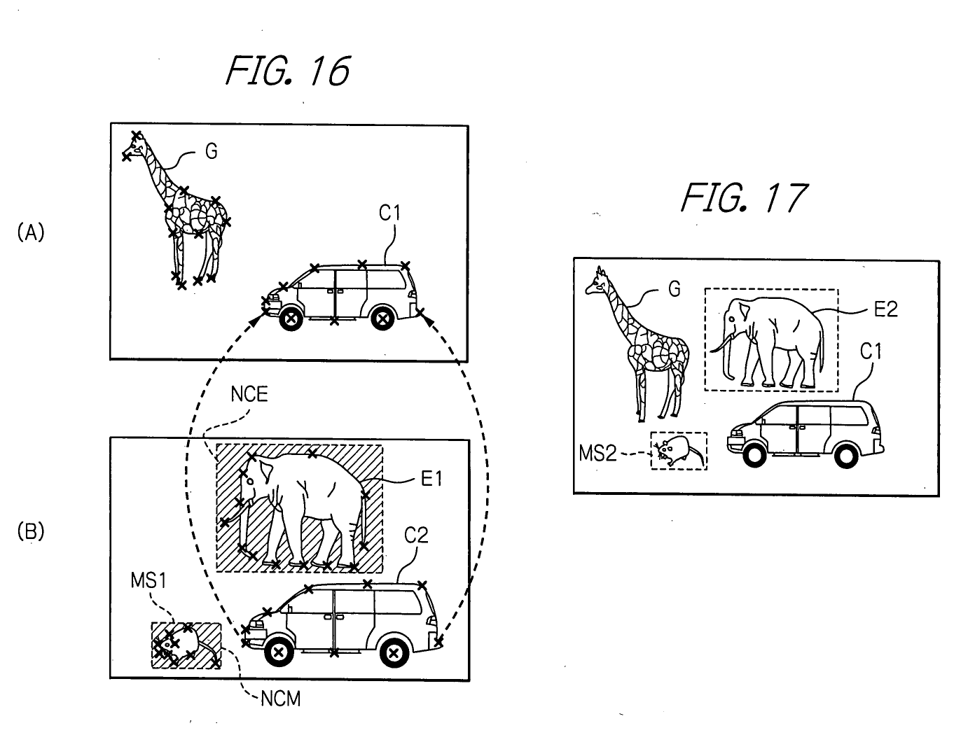

FIG. 16, parts (A) and (B), and FIG. 17 show a still another alternative embodiment in which images are combined together with respect to the same automobile. FIG. 16, parts (A) and (B), and FIG. 17 show a base image, a superimposition image, and their composition image, respectively. In FIG. 16, part (B), its non-common sub-regions against the base image are referred to as NCE and NCM.

The base image contains an automobile C1 and a giraffe G, while the superimposition image contains an automobile C2 which is the same as the automobile C1, an elephant E1, and a mouse MS1. The image composer 1 or 1a can produce their composite image with respect to the same automobile C1, in which image there are the original giraffe G, a reduced elephant E2 and a reduced mouse MS2, simultaneously as shown in FIG. 17.

Note that the above-described processing steps in the image composer 1 or 1a can be implemented by a program sequence for causing the central processing unit (CPU) of a computer to execute those steps.

While the present invention has been described with reference to the particular illustrative embodiments, it is not to be restricted by the embodiments. It is to be appreciated that those skilled in the art can change or modify the embodiments without departing from the scope and spirit of the present invention. For example, by performing all or part of each of the above-described processing steps more than once, the image composer 1 or 1a can produce a composite from three or more original images.

The image composer 1 or 1a, in addition to personal computers, can also be implemented by digital cameras, camera-built-in cellular phones, etc. This makes it possible to produce a composite image at the location where photographs were taken, and then confirm the contents thereof.

In the case where a building, which is common to more than two original images, have been photographed at slightly different angles, each superimposition image may be coordinate-transformed so that the feature points of the building in the base image coincide with those in the superimposition image, or the superimposition image may be coordinate-transformed into only a similar form. In this case, accompanying with the transformation of the common sub-region, the superimposition region, i.e. the non-common sub-region, may be coordinate-transformed into a dissimilar or similar form. If the superimposition region is transformed into similar form, even though the other region is coordinate-transformed into a dissimilar form, a person or another object in the superimposition region can be prevented from being undesirably transformed in accordance with the coordinate transformation.

It should be noted that superimposition regions are not limited to be rectangular in shape. Examples of the shapes may be triangular, pentagonal, hexagonal, circular, elliptical, starlike, heart-shaped, and so on. Finally, the hardware units, flowcharts, and other details given herein can be changed or modified without departing from the scope of the present invention hereinafter claimed.

The entire disclosure of Japanese patent application No. 2007-76035 filed on Mar. 23, 2007, including the specification, claims, accompanying drawings and abstract of the disclosure, is incorporated herein by reference in its entirety.

What is claimed is:

1. An image composer comprising:
a storage for storing data of a first image and a second image;
a region classifier for comparing the first and second images with each other, and extracting a partial region of the second image as a non-common sub-region, the partial region having a pixel property not similar to the pixel property of a region of the first image corresponding to the partial region; and
an image composing unit for superimposing the extracted non-common sub-region of the second image on the first image to produce a composite image.

2. The image composer in accordance with claim 1, wherein each of the first and second images contains a common subject in part of a region of the first and second images, said image composing unit deciding, based on a position of the common subject, a position in the first image where the non-common sub-region will be superimposed.

3. The image composer in accordance with claim 1, further comprising at least either of a display device for displaying the composite image and a display controller for instructing an external display device to display the composite image.

4. The image composer in accordance with claim 1, wherein the pixel property is a scalar value or a vector value calculated from one or more pixels.

5. The image composer in accordance with claim 4, wherein the scalar value is a pixel value in one or more pixels or an average value of the pixel values, the vector value being a luminance vector or a luminance differential vector in one or more pixels.

6. The image composer in accordance with claim 1, further comprising:
a feature extractor for extracting a specific part of each of the first and second images as a feature point, and extracting a feature pattern of the feature point, the feature pattern being invariant to change in a scale and an orientation of the images; and
a feature checker for putting the feature point of the first and second images in correspondence as a corresponding point pair when a measure of similarity between the feature patterns is substantially equal to or greater than a threshold value;
said region classifier extracting as the non-common sub-region a partial region that contains a partial set of features not adopted as the corresponding point pair.

7. The image composer in accordance with claim 6, wherein said region classifier extracts as the non-common sub-region a rectangle circumscribing the partial set of features not adopted as the corresponding point pair.

8. The image composer in accordance with claim 6, wherein information about the feature point includes:
at least either of a scale value representative of a scale ratio of each of the images and an degree of orientation of each image based on a predetermined reference point and a reference direction;
the feature pattern; and
a coordinate value representative of a coordinate of a specific point in each image.

9. The image composer in accordance with claim 2, wherein said image composing unit superimposes the non-common sub-region onto the first image so that its relative position and size to the common subject do not change.

10. The image composer in accordance with claim 9, wherein said image composing unit employs an image transformation parameter calculated from a coordinate value of the feature point of the first and second images which is adopted as the corresponding point pair on a basis of a measure of similarity between the points equal to or greater than a threshold value, and from at least either of the scale value of each of the first and second images or a degree of orientation of the feature points, to decide a position on the first image, at which the non-common sub-region is superimposed.

11. An image compositing program for combining a first image and a second image together by executing on a computer the steps of:
comparing the first and second images read out from a storage equipped in the computer to thereby extract a partial region of the second image as a non-common sub-region which does not have a similar pixel property to the pixel property of a corresponding region of the first image; and
superimposing the extracted non-common sub-region onto the first image to produce a composite image.

12. The image compositing program in accordance with claim 11, wherein the composite image is produced from three or more images by performing at least partially said steps more than once.
